(19) United States
(12) Patent Application Publication
(10) Pub. No.: US 2004/0013110 A1
(43) Pub. Date: Jan. 22, 2004

(54) Integration media processing into a PBX/KTS system using DSP in skin technology

(76) Inventor: Mehmet E. Binal, Southport, CT (US)

Correspondence Address: Charles N.J. Ruggiero, Esq., Ohlandt, Greeley, Ruggiero & Perle, L.L.P., 10th Floor, One Landmark Square, Stamford, CT, 06901-2682, US

(21) Appl. No.: 10/439,678

(22) Filed: May 16, 2003

Related U.S. Application Data
(60) Provisional application No. 60/381,537, filed on May 17, 2002.

(51) Int. Cl. G06F 15/00; H04M 1/64; H04L 12/66

(52) U.S. Cl. 370/355; 712/35; 379/88.07

(57) ABSTRACT

A media processing platform includes an interface to a PBX/KTS backplane, a digital signal processor (DSP), and a high-speed link to a remote computer. One or more drivers are provided to support communication between the DSP and an application running on the remote computer. The one or more drivers also include the ability to provide continued operations if communication over the high-speed link is lost and then recovered.

This application claims the benefit of U.S. Provisional Application Serial No. 60/381,537 filed on May 17, 2002, the entire contents of which is incorporated herein.

### BACKGROUND OF THE INVENTION

1. Field of the Invention

The present invention relates to voice/data communication systems. More particularly, the present invention relates to a voice/data communication system having a digital signal processor (DSP) for preprocessing private branch exchange (PBX) or key telephone system (KTS) (PBX/KTS) signals.

2. Description of the Prior Art

In currently available PBX/KTS systems, preprocess digital signal processing (DSP), also referred to as DSP media processing, may be provided by internal or external systems.

External media processing systems generally include a DSP media processor installed in a separate computer. An external system usually requires additional equipment connected to a costly front end interface. The interface is used to connect to the PBX proprietary telephone line. In addition, a line card needs to be allocated to interface to the external system, reducing channel capacity. In most external systems available today, the DSP media processing data is processed by a personal computer (PC). In these systems, DSP data processing is subject to constraints of the computer bus, including bus timing, memory access, interrupt response time and the like.

Internal media processing systems, also referred to as in skin systems, typically include a DSP media processor integrated with a PC on a printed circuit board (PCB). An example of an internal media processing system is shown in FIG. 1. A PCB 100 plugs into the PBX/KTS backplane. PCB 100 has a PBX/KTS backplane interface 105, a DSP media processor 110, and, in this example, a built-in PC 115. There is no need for a line card or electronics to interface to the line card, because the internal system interfaces directly to the PBX/KTS backplane. In addition, reliability is enhanced, because there are no external wires, cables, or connectors interposed between the various pieces of equipment. However, this type of system is limited by the size of the PBX/KTS backplane slot and the power available from the PBX backplane. This type of system typically has a higher number of signal processing channels, and thus requires enhanced cooling requirements due to the corresponding increase in signal processing power. In some cases, these factors prohibit installation of such a system into a PBX/KTS.

The operation of both internal and external systems depends on the associated computer. This dependency is such that any problem with the computer typically results in a catastrophic failure. Once the problem has been eliminated, both the internal and external DSP media processing systems are restarted and communication reestablished to the PBX/KTS.

The present invention provides a DSP media processing platform that easily integrates into the backplane of a PBX or KTS system. A standard high-speed link transports DSP data to an application programming interface, running on a remote computer. This eliminates the need for a line card interface in favor of a simpler PBX/KTS backplane interface. This also eliminates the need for a dedicated computer to process DSP data. This high-speed link provides seamless connectivity by using drivers that reside on either end of the link. The drivers also manage a graceful shutdown in the event that the link is severed. When the link is restored, the drivers reestablish communication. A plug-and-play feature automatically detects the high-speed link between the driver or driver components and automatically initiates DSP and data transfer. The DSP media processing platform operates independently of a computer bus and eliminates the constraints imposed by the computer environment. In addition, the DSP media processing platform of the present invention uses a standard communication protocol across the link. As a result, proprietary PBX/KTS interface circuits and protocols are only needed at the interface between the DSP media processor and the PBX/KTS backplane.

### SUMMARY OF THE INVENTION

It is an object of the present invention to provide media processing for a PBX/KTS system.

It is another object of the present invention to integrate DSP media processing into the backplane of a PBX or KTS system.

It is yet another object of the present invention to use a standard high-speed link to transport DSP data to an application programming interface (API) running on a remote computer.

It is a further object of the present invention to provide for controlled operations, if the link is lost and to reestablish the link automatically when the link is restored.

It is a still further object of the present invention to provide a DSP media processing platform that operates free of the constraints of a computer bus.

It is a still further object of the invention to provide a standard interface across the link that isolates proprietary PBX/KTS system interface circuits and protocols.

These and other objects and advantages of the present invention are achieved by a DSP media processing platform comprising an interface to a PBX/KTS backplane, a DSP, a high-speed link to a remote computer, and one or more drives to support communication between the DSP and an application running on the remote computer. The one or more drivers of the present invention have the ability to provide continued operations, if communication over the high-speed link is lost.

Other and further objects, advantages and features of the present invention will be understood by reference to the following.

### BRIEF DESCRIPTION OF THE DRAWINGS

FIG. 1 is a block diagram of an example of a prior art internal DSP media processing system;

FIG. 2 is a block diagram of a system in which the DSP media processing platform of the present invention is installed;

FIG. 3 is a block diagram of a printed circuit board (PCB) of the present invention; and

FIG. 4 is a more detailed block diagram of the printed circuit board (PCB) of the present invention.

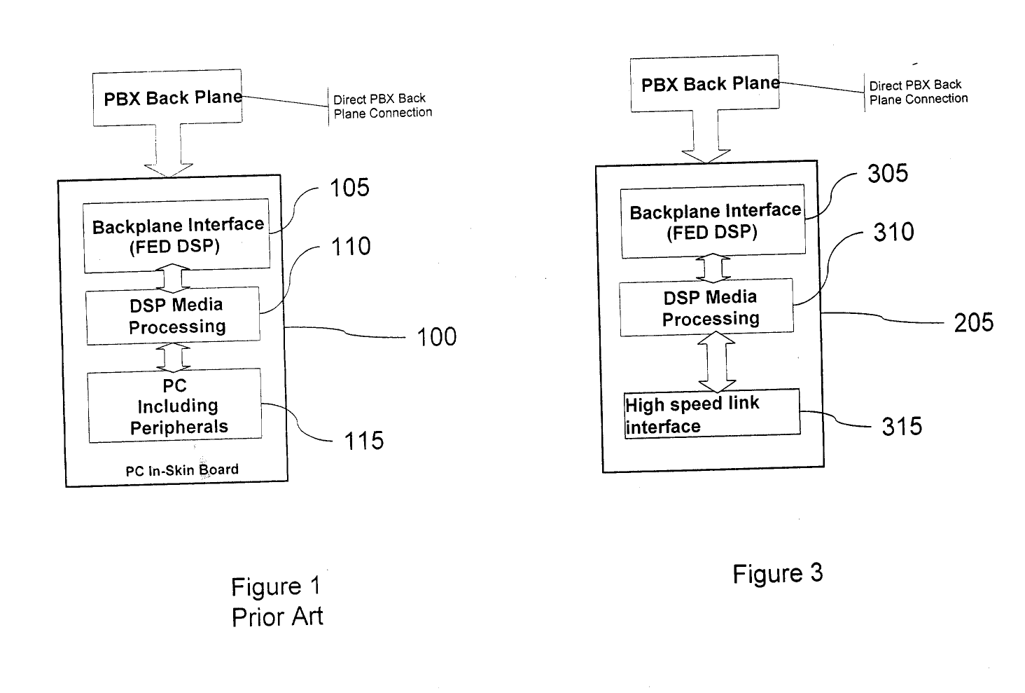

### DESCRIPTION OF THE INVENTION

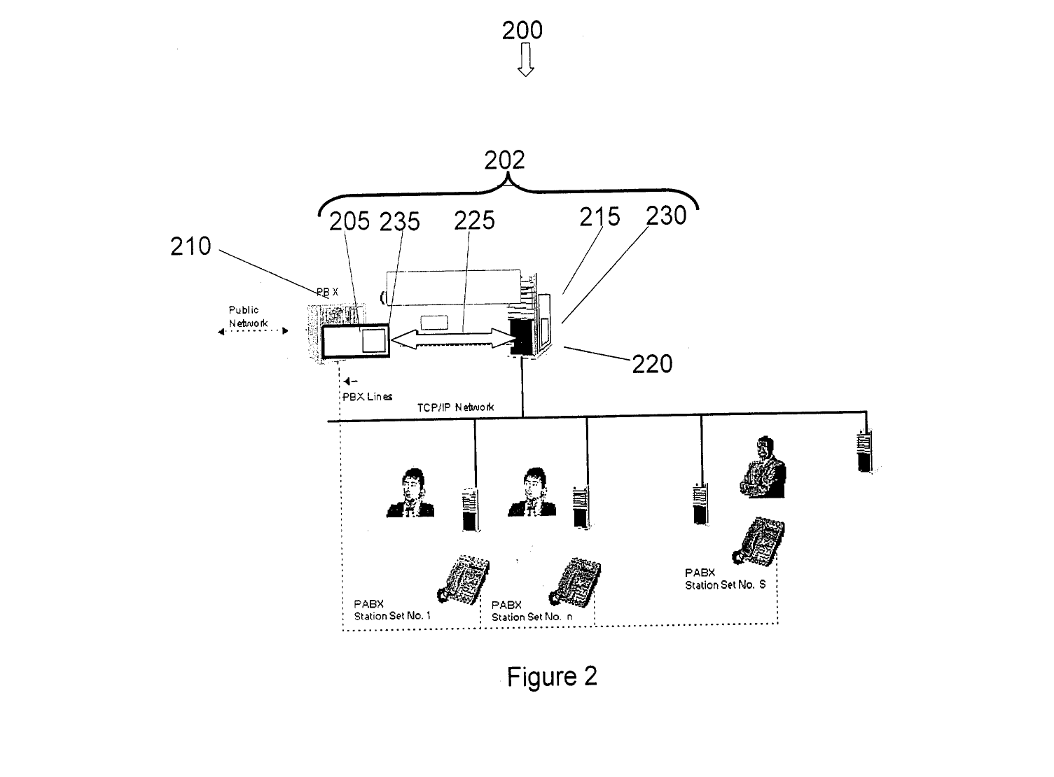

Referring to the drawings and, in particular, FIG. 2, there is shown a system of the present invention generally represented by reference numeral 200. System 200 has a DSP media processing platform 202.

The DSP media processing platform 202 has a PCB 205 that plugs into a PBX/KTS system 210 and an application 215 running on a remote computer 220. PCB 205 communicates with application 215 through a high-speed link 225.

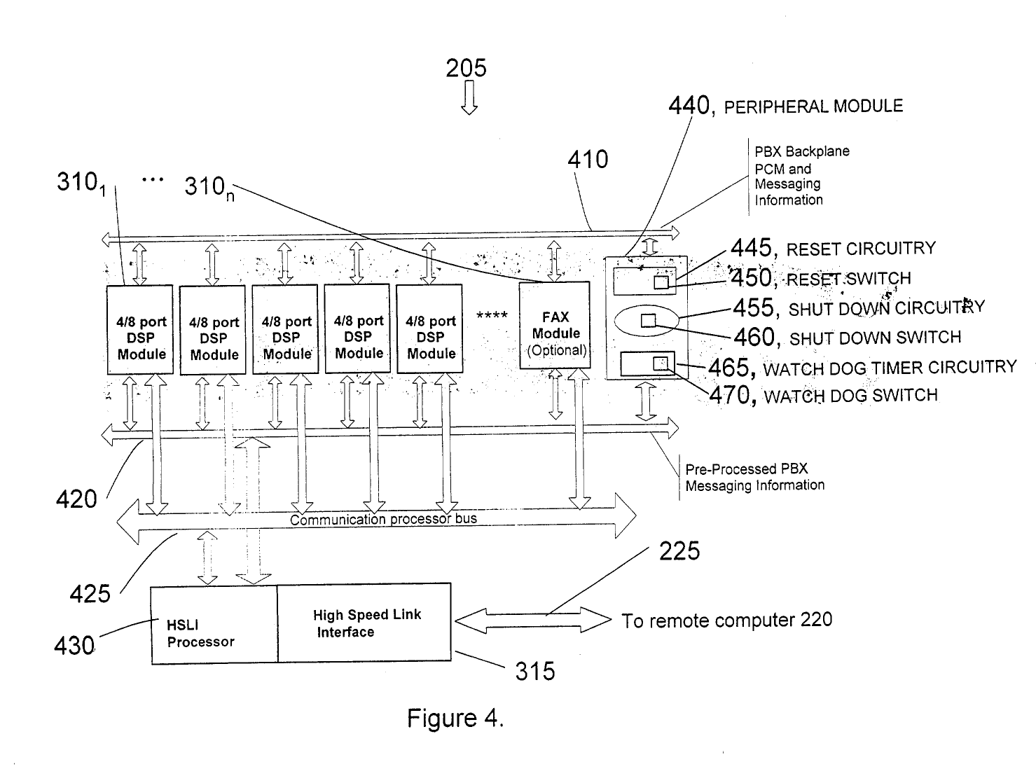

FIG. 3 shows a block diagram of PCB 205. PCB 205 has a backplane interface 305 that connects to a PBX/KTS backplane, such as backplane 410 shown in FIG. 4, a DSP media processor 310, and a high-speed link interface 315.

If the PBX/KTS backplane conforms to a particular standard, backplane interface 305 is a generic or a standard interface. Otherwise, it is designed to interface to a custom backplane.

DSP media processor 310 directs digitized data to high-speed link interface 315. High-speed link interface 315 packetizes the digitized data and sends the packetized data over high-speed link 225 to remote computer 220 (FIG. 2).

Referring to FIG. 2, media processing platform 202 provides pre-processing for a number of applications, including unified messaging, voice mail, call center, fax server, voice gateway, and interactive voice response (IVR) functionality.

Application 215 is run on any suitable computing device, including a PC, a network server, or any other device capable of providing the computing services needed by application 215. Using application 215, other applications go on-hook or off-hook, make calls through the PBX, record or play messages, forward calls, and execute other PBX/KTS system functions.

Referring to FIGS. 2 and 3, application 215 has an application driver 230 and PCB 205 has a DSP driver 235, preferably included as part of high-speed link interface 315 shown in FIG. 3. Application driver 230 and DSP driver 235 operate to regularly transmit a special packet between remote computer 220 and PCB 205. If any one of these packets is not received in a set period of time, a message indicating that the communication over high-speed link 225 has failed is transmitted to application 215. Similarly, as shown in FIG. 3, high speed link interface 315 informs DSP media processor 310 of the communication failure. DSP media processor 310 initiates a graceful shut-down process and plays a short message to a caller indicating that the system 200 is temporarily out of order. The DSP media processor 310 shut down process is independent of application 215 running on remote computer 220.

Upon being informed of the communication failure, application 215 enters a polling mode. The polling mode regularly interrogates DSP driver 235. Upon receiving a response, application 215 informs remote computer 220 that communication over high-speed link 225 is again available and reestablishes the link and the communication process. DSP driver 235 informs DSP media processor 310 that communication has been reestablished and resumes the communication process. DSP media processor 310 terminates the short message to callers and proceeds to process digital data.

Thus in this example, the drivers, application driver 230, and DSP driver 235 provide continued operation when communication over the high-speed link is lost and then recovered.

FIG. 4 shows a more detailed block diagram of PCB 205 (FIG. 3). Multiple DSPs 310₁ . . . 310ₙ provide additional signal processing capability and are connected to PBX/KTS backplane 410 by plugging into PCB 205. Digitized data is transferred among multiple DSPs 310₁ . . . 310ₙ over a pre-processed data bus 420. High-speed link interface 315 includes a high-speed link interface (HSLI) processor 430 to control the data transfer over pre-processed data bus 420. Digital data is exchanged with high-speed link interface 315 over communication processor bus 425 or, optionally, over pre-processed data bus 420.

PCB 205 preferably has a peripheral module 440 that provides reset circuitry 445, shut down circuitry 455, and watch dog timer circuitry 465. These circuits are controlled by high-speed link interface processor 430 and by reset switch 450, shut down switch 460, and watch dog switch 470.

The media processing platform is described in the context of a hardware and software combination of PCB 205, application 215, and DSP driver 235, and applications driver 230 communicating over high-speed link 225. However, it should be understood that the media processing platform is implementable solely in hardware or solely in software, or in any combination of hardware and software suitable for providing the functions of the present invention.

The DSP 310 and the application 215 are described as connected through high-speed link 225 utilizing DSP driver 235 and application driver 230, respectively. While discussed in the context of a local area network (LAN), universal serial bus (USB), or 1394 (firewire) communication link, it should be understood that high-speed link 225 is any link suitable for exchanging data between DSP media processor 310 and application 215. IEEE 1394, “High Performance Serial Bus,” is an electronics standard for connecting devices to a PC.

The present invention having been thus described with particular reference to the preferred forms thereof, it will be obvious that various changes and modifications may be made therein without departing from the spirit and scope of the present invention as defined in the appended claims.

What is claimed is:

1. A method of managing communication failure, comprising:
automatically reestablishing, by a digital signal processing (DSP) driver and an application driver, said communication link and providing continued operation when a communication link between a printed circuit board (PCB) and a remote computer is lost.

2. The method according to claim 1, further comprising:
periodically transmitting, by said DSP driver and said application driver, one or more packets between said remote computer and said PCB;
sending a communication-failed message to an application and a digital signal processing (DSP) media processor, upon detecting that one of said one or more packets is not timely received;
initiating, by said DSP media processor, a shut-down process;
entering, by said application, a polling mode and regularly interrogating said DSP driver, upon receiving said communication-failed message; and
informing said remote computer that communication is reestablished.

3. The method according to claim 2, further comprising
playing a message to a caller indicating an out-of-order status.

4. A method of media processing, comprising:
connecting a plurality of digital signal processors (DSPS) to a backplane via a printed circuit board (PCB);
transferring data among said plurality of DSPs over a bus; and
controlling said data transfer over said bus with a high-speed link interface.

5. The method according to claim 4, wherein said backplane is a type selected from the group consisting of public branch exchange (PBX), key telephone system (KTS), and any combination of PBS/KTS.

6. The method according to claim 4, wherein said bus is a pre-processed data bus.

7. The method according to claim 4, wherein said high-speed link interface includes a high-speed link interface (HSLI) processor.

8. A digital signal processing (DSP) platform, comprising:
a processor;
a high-speed link connected to said processor;
an application to be run by said processor;
a telephone system; and
a printed circuit board (PCB) for connection to said telephone system and to communicate with said application through said high-speed link.

9. The DSP platform according to claim 8, further comprising:
an application driver to be run by said processor; and
a DSP driver connected to said PCB to operate with said application driver to periodically transmit a packet between said PCB and said processor,
wherein said application, said application driver, and said DSP driver provide continued operation when communication fails and is later recovered.

10. The DSP platform according to claim 9, further comprising transmitting a communication-failure message to said application when said packet is not timely received.

11. The DSP platform according to claim 10, wherein said application enters a polling mode upon receiving said communication-failure message.

12. The DSP platform according to claim 9, wherein said application periodically interrogates said DSP driver.

13. The DSP platform according to claim 12, further comprising sending a communication-available message by said application to said processor upon receiving a response from said DSP driver.

14. The DSP platform according to claim 13, further comprising reestablishing communication by said application upon said DSP driver informing said processor that communication is able to be reestablished.

15. The DSP platform according to claim 9, further comprising a shut-down process to be run by said processor to initiate a shut-down.

16. The DSP platform according to claim 15, wherein said shut-down process provides a message to a caller.

17. The DSP platform according to claim 15, wherein said shut-down process is independent of said application.

18. The DSP platform according to claim 9, wherein said high-speed link transports DSP data to an application programming interface (API) running on a remote computer, and wherein said application and said application driver are also running on said remote computer.

19. The DSP platform according to claim 8, wherein said telephone system is a type selected from the group consisting of public branch exchange (PBX), key telephone system (KTS), and any combination of PBX/KTS.

20. The DSP platform according to claim 8, wherein said high-speed link packetizes and sends data to said processor.

21. The DSP platform according to claim 8, wherein said application is selected from the group consisting of: unified messaging, voice mail, call center, fax server, voice gateway, and interactive voice response (IVR).

22. The DSP platform according to claim 8, wherein said telephone system performs a function selected from the group consisting of going on-hook, going off-hook, making a call, recording a message, playing a message, and forwarding a call.

23. The DSP platform according to claim 8, wherein said PCB comprises:
a pre-processed data bus; and
a plurality of DSPs connected to a backplane,
wherein data is transferred among said plurality of DSPs over said pre-processed data bus.

24. The DSP platform according to claim 23, wherein said high-speed link includes a high-speed link interface (HSLI) processor to control data transfer over said pre-processed data bus.

25. The DSP platform according to claim 24, wherein data is exchanged with a high-speed link interface over a communication processor bus.

26. The DSP platform according to claim 25, wherein said data is exchanged with said high-speed link interface over said pre-processed data bus.

27. The DSP platform according to claim 24, wherein said high-speed link interface isolates proprietary PBX/KTS system interface circuits and protocols.

28. The DSP platform according to claim 24, wherein said PCB further comprises a peripheral module having reset circuitry, shut-down circuitry, and watch dog timer circuitry, wherein said reset circuitry, said shut-down circuitry, and said watch dog timer circuitry are controlled by said HSLI processor.

29. The DSP platform according to claim 28, wherein said peripheral module further comprises a reset switch, a shut-down switch, and a watch dog timer switch to further control said reset circuitry, said shut-down circuitry, and said watch dog timer circuitry respectively.
